(19) United States
(12) Patent Application Publication
(10) Pub. No.: US 2017/0152702 A1
(43) Pub. Date: Jun. 1, 2017

(54) SMART WINDOW

(71) Applicant: NANOBIT TECH. CO., LTD., Taoyuan County (TW)

(72) Inventors: Yu-Yang CHANG, Taoyuan County (TW); Shiou-Ming LIU, Taoyuan County (TW); Te-Liang YU, Taoyuan County (TW); Fu-Tien KU, Taoyuan County (TW)

(21) Appl. No.: 15/008,434

(22) Filed: Jan. 27, 2016

(30) Foreign Application Priority Data
Nov. 27, 2015 (TW) 104219072

(51) Int. Cl. E06B 3/67; G02F 1/133; G02F 1/1343; G02F 1/1334; G02F 1/137

(52) U.S. Cl. CPC E06B 3/6722; G02F 1/1334; G02F 1/137; G02F 1/13439; G02F 1/13306; G02F 2001/13756

(57) ABSTRACT

The invention provides a smart window. The smart window comprises at least one composite layer comprising: a first soft resin sheet, a first transparent conductive layer, a second soft resin sheet, a second transparent conductive layer and a first PDLC layer. The first and second transparent conductive layers are etched to form circuit regions with different patterns, and first leads and second leads on the circuit regions are electrically connected with an external electrically driving device. The first PDLC layer is driven to present different patterns by an electric field controlled by a signal instruction of the external electrically driving device.

### BACKGROUND OF THE INVENTION

Field of the Invention

The present invention relates to a smart window, more particularly to a smart window which has a PDLC layer and a plurality of conductive layers having different patterns.

Description of the Related Art

A traditional polymer dispersed liquid crystal (PDLC) is formed by using anisotropic liquid crystal droplets distributing in polymers uniformly, typically anisotropic liquid crystal droplets with positive dielectric constant distributing in polymers uniformly that have no a specific direction in a normal state, and the light transmitted through the anisotropic liquid crystal droplets fails to match with the refractive index of the polymers so that incident light may scatter seriously due to many interfaces existing and light transmission rate is low. If a specific electric field is provided, the anisotropic liquid crystal droplets with positive dielectric constant may be arranged forward along the electric field, and the light transmitted through the anisotropic liquid crystal droplets with positive dielectric constant may match with the refractive index of the polymers so that the most incident light may transmit through forward and the light transmission rate is increased. Smart windows are formed by packaging PDLC in transparent substrates such as conductive glasses and switching the electric field on or off to control the change of transparency of the transparent substrates. Smart windows can dynamically change the tinting of glass to control the amount of light/heat that enters a building. They can also be used to create on-demand private spaces for offices. Recently, soft conductive transparent resins have been used to package PDLC instead of the conductive glasses by the advancing process and material so that the process can be simplified greatly and the application of the related products can be enhanced greatly. For example, the structure of soft conductive transparent resins packaging PDLC in combination with transparent adhesive technologies can be attached on glass of buildings, windows of cars, refrigerators or projection walls for increasing use of applications.

However, in the application of buildings or commercial demand, as the size of the structure is enlarged and it is not desired to have a complicated pattern design, a complicated circuit structure of the electrically driving device and the cost for producing a change of pattern, there is a need for a new structure.

### SUMMARY OF THE INVENTION

It is an object of the present invention to disclose a smart window having a composite layer. The smart window mainly comprises at least one PDLC layer that is sandwiched in a plurality of transparent conductive layers. The transparent conductive layers are etched to form circuit regions with different patterns. The PDLC layer is driven to present different patterns by an electric field controlled by a signal instruction of an external electrically driving device.

It is another object of the present invention to disclose a smart window. The smart window is formed by a transparent adhesive layer attaching to a plurality of composite layers. Also, a plurality of transparent conductive layers and PDLC layers may be made on one side or two sides of the above-mentioned composite layer.

It is still another object of the present invention to disclose a smart window. The smart window is connected to an external electrically driving device through FPC, and the external electrically driving device can drive the patterned circuits of the transparent conductive layers to present different patterns.

Accordingly, the invention provides a smart window comprising at least one composite layer, electrically connected with an external electrically driving device, the composite layer comprising: a first soft resin sheet, a first transparent conductive layer, a second soft resin sheet, a second transparent conductive layer and a first PDLC layer.

The first soft resin sheet has a first curing layer on a side surface thereof. The first transparent conductive layer is provided on a side surface of the first curing layer, and electrically connected with the external electrically driving device, and the first transparent conductive layer comprises a first circuit region, a plurality of first leads electrically connecting with the first circuit region and a first cable region electrically connecting with the first leads. The second soft resin sheet has a second curing layer on a side surface thereof. The second transparent conductive layer is provided on a side surface of the second curing layer, and electrically connected with the external electrically driving device, and the second transparent conductive layer comprises a second circuit region, a plurality of second leads electrically connecting with the second circuit region and a second cable region electrically connecting with the second leads. The first polymer dispersed liquid crystal (PDLC) layer is provided between the first transparent conductive layer and the second transparent conductive layer, wherein the first circuit region or the second circuit region is driven respectively by the electrically driving device to produce a local change of an electric field for achieving a change of light transmission of local region of the first PDLC layer.

Accordingly, the invention further provides a smart window, electrically connected with an external electrically driving device, comprising: a first soft resin sheet, a first transparent conductive layer, a second soft resin sheet, a second transparent conductive layer, a first PDLC layer, a third transparent conductive layer, a third soft resin sheet, a fourth transparent conductive layer and a second PDLC layer.

The first soft resin sheet has a first curing layer on a side surface thereof. The first transparent conductive layer is provided on a side surface of the first curing layer, and electrically connected with the external electrically driving device, and the first transparent conductive layer comprises a first circuit region, a plurality of first leads electrically connecting with the first circuit region and a first cable region electrically connecting with the first leads. The second soft resin sheet has a second curing layer on a side surface thereof. The second transparent conductive layer is provided on a side surface of the second curing layer, and electrically connected with the external electrically driving device, and the second transparent conductive layer comprises a second circuit region, a plurality of second leads electrically connecting with the second circuit region and a second cable region electrically connecting with the second leads. The first PDLC layer is provided between the first transparent conductive layer and the second transparent conductive layer. The third transparent conductive layer is provided on a side surface of a third curing layer, and electrically connected with the external electrically driving device, and the third transparent conductive layer comprises a third circuit region, a plurality of third leads electrically connecting with the third circuit region and a third cable region electrically connecting with the third leads. The third soft resin sheet has a fourth curing layer on a side surface thereof. The fourth transparent conductive layer is provided on a side surface of the fourth curing layer, and electrically connected with the external electrically driving device, and the fourth transparent conductive layer comprises a fourth circuit region, a plurality of fourth leads electrically connecting with the fourth circuit region and a fourth cable region electrically connecting with the fourth leads. The second PDLC layer is provided between the third transparent conductive layer and the fourth transparent conductive layer, wherein the first circuit region, the second circuit region, the third circuit region or the fourth circuit region is driven respectively by the electrically driving device to produce a local change of an electric field for achieving a change of light transmission of local region of the first PDLC layer or the second PDLC layer.

In an aspect of the invention, each the first soft resin sheet, the second soft resin sheet and the third soft resin sheet has a recess at a side for exposing the first cable region of the first transparent conductive layer and the second cable region of the second transparent conductive layer. The first leads, the second leads, the third leads and the fourth leads are coated with a conductive adhesive layer respectively, wherein the conductive adhesive layer is silver paste. The conductive adhesive layers of the first leads, the second leads, the third leads and the fourth leads are electrically connecting to each of an end of a plurality of flexible printed circuits (FPCs), and the FPCs are electrically connecting to the electrically driving device at another end respectively.

In an aspect of the invention, the first soft resin sheet, the second soft resin sheet and the third soft resin sheet are a material of light transmission resin, wherein the light transmission resin is polyethylene terephthalate (PET), polyethylene (PE), polyimide (PI), polyamide (PA), polyurethanes (PU) or acrylic resin. The first soft resin sheet has a thickness in a range of 10 um-500 um, the second soft resin sheet has a thickness in a range of 10 um-500 um and the third soft resin sheet has a thickness in a range of 10 um-500 um. The first curing layer, the second curing layer, the third curing layer or the fourth curing layer is a material selected from the group consisting of acrylic resin, epoxy and silica. The first curing layer, the second curing layer, the third curing layer or the fourth curing layer has a thickness in a range of 1 um-5 um.

In an aspect of the invention, the first transparent conductive layer, the second transparent conductive layer, the third transparent conductive layer and the fourth transparent conductive layer are made of an inorganic conductive material or an organic conductive material, wherein the organic conductive material is a conductive material mixing with carbon nanotube or poly-3,4-ethylenedioxythiophene. The first transparent conductive layer, the second transparent conductive layer, the third transparent conductive layer or the fourth transparent conductive layer has a thickness in a range of 5 nm-50 um. The first PDLC layer or the second PDLC layer is formed of PDLC resins as a main element and mixing with a material selected from the group consisting of UV resins, thermal setting resins and silica. The first PDLC layer or the second PDLC layer has a thickness in a range of 1 um-100 um.

In an aspect of the invention, the smart window further comprises an upper light transmission layer, a lower light transmission layer and an optical adhesive layer provided between the upper light transmission layer and the lower light transmission layer, and the optical adhesive layer wrapping the composite layer inside. The composite layer is attached to another composite layer by the first soft resin sheet or the second soft resin sheet with a transparent adhesive layer.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows a side view of a composite layer used in a smart window of a first embodiment according to the present invention.

FIG. 2 shows a side view of two composite layers used in a smart window of a second embodiment according to the present invention.

FIG. 3 shows a side view of two composite layers used in a smart window of a third embodiment according to the present invention.

FIG. 4 shows a side view of a composite layer used in a smart window of a fourth embodiment according to the present invention.

FIG. 5 shows a top view FIG. 4 from direction of a first soft resin sheet.

FIG. 6 shows a top view FIG. 4 from direction of a second soft resin sheet.

FIG. 7 shows a schematic view of a composite layer of a fourth embodiment electrically connecting to an external electrically driving device according to the present invention.

FIG. 8 shows a schematic view of a first image effect of FIG. 1 of a first embodiment according to the present invention.

FIG. 9 shows a schematic view of a second image effect of FIG. 1 of a first embodiment according to the present invention.

### DETAILED DESCRIPTION OF THE INVENTION

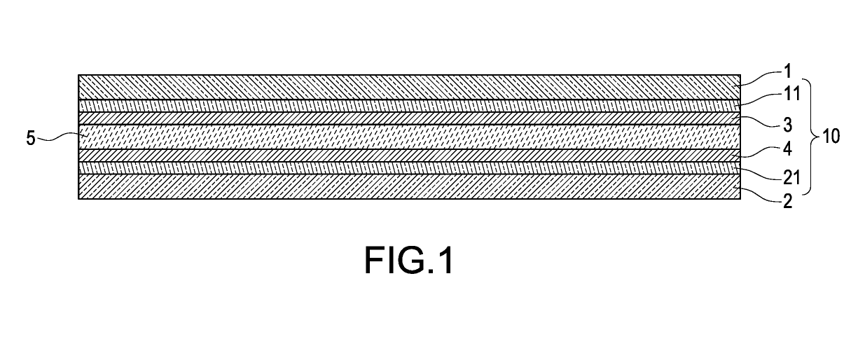

FIG. 1 shows a side view of a composite layer used in a smart window of a first embodiment according to the present invention. In an embodiment, a smart window comprises at least one composite layer 10 for controlling light transmission of local region. According to FIG. 1, the composite layer 10 comprises a first soft resin sheet 1, a second soft resin sheet 2, a first transparent conductive layer 3, a second transparent conductive layer 4 and a first polymer dispersed liquid crystal (PDLC) layer 5.

The first soft resin sheet 1 and the second soft resin sheet 2 are a material of light transmission resin. The light transmission resin is polyethylene terephthalate (PET), polyethylene (PE), polyimide (PI), polyamide (PA), polyurethanes (PU) or acrylic resin, etc. The first soft resin sheet 1 and the second soft resin sheet 2 have a thickness in a range of 10 um-500 um. Also, a first curing layer 11 is formed on a side surface of the first soft resin sheet 1 by a curing treatment. A second curing layer 21 is formed on a side surface of the second soft resin sheet 2 by a curing treatment. The material used in the first curing layer 11 and the second curing layer 21 is selected from the group consisting of acrylic resin, epoxy and silica. The first curing layer 11 has a thickness in a range of 500 nm-50 um, and preferably, in a range of 1 um-5 um. The second curing layer 21 has a thickness in a range of 500 nm-50 um, and preferably, in a range of 1 um-5 um.

The first transparent conductive layer 3 is provided on a side surface of the first curing layer 11. The first transparent conductive layer 3 is a circuit or conductive block formed by dry etching or wet etching with inorganic conductive material of metallic oxides such as silver oxide, nano-silver oxide or indium tin oxide (ITO), or organic conductive material such as carbon nanotube or poly-3,4-ethylenedioxythiophene (PEDOT) that has the light transmission rate of 70%-95%. The first transparent conductive layer 3 has a thickness in a range of 5 nm-50 um, and preferably, in a range of 100 nm-10 um.

The second transparent conductive layer 4 is provided on a side surface of the second curing layer 21, and corresponded with the first transparent conductive layer 3. The second transparent conductive layer 4 is a circuit or conductive block formed by dry etching or wet etching with inorganic conductive material of metallic oxides such as silver oxide, nano-silver oxide or indium tin oxide (ITO), or organic conductive material such as carbon nanotube or poly-3,4-ethylenedioxythiophene (PEDOT) that has the light transmission rate of 70%-95%. The second transparent conductive layer 4 has a thickness in a range of 5 nm-50 um, and preferably, in a range of 100 nm-10 um.

The PDLC layer 5 is provided between the first transparent conductive layer 3 and the second transparent conductive layer 4. The PDLC layer 5 has a thickness in a range of 1 um-100 um. The PDLC layer 5 is formed of PDLC resins as a main element and mixing with a material selected from the group consisting of UV resins, thermal setting resins and silica, wherein PDLC resins have the light transmission rate of 50%-80% and refractive index of 1.5-5.5 after electric conduction.

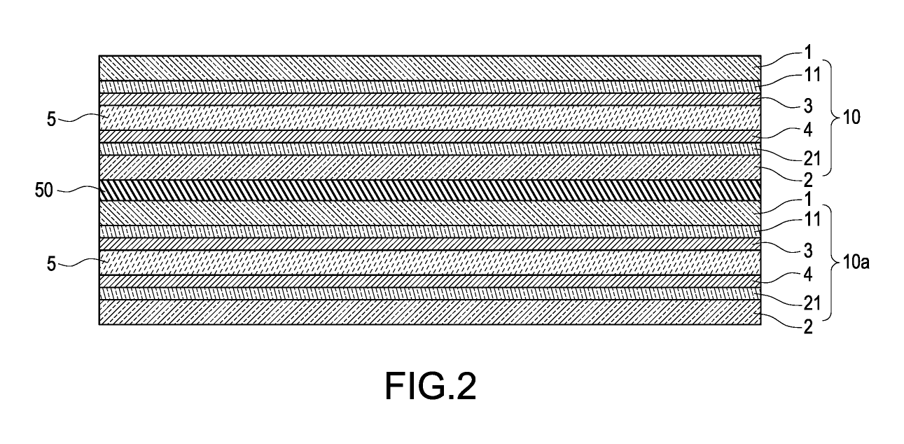

FIG. 2 shows a side view of two composite layers used in a smart window of a second embodiment according to the present invention. Please refer to FIG. 2. The difference between the second embodiment of FIG. 2 and the first embodiment of FIG. 1 is that the composite layer 10 is attached to another composite layer 10a by the first soft resin sheet 1 or the second soft resin sheet 2 with a transparent adhesive layer 50. The composite layer 10a has the same structure to the composite layer 10. In FIG. 2, the transparent adhesive layer 50 has optical clear adhesive (OCA).

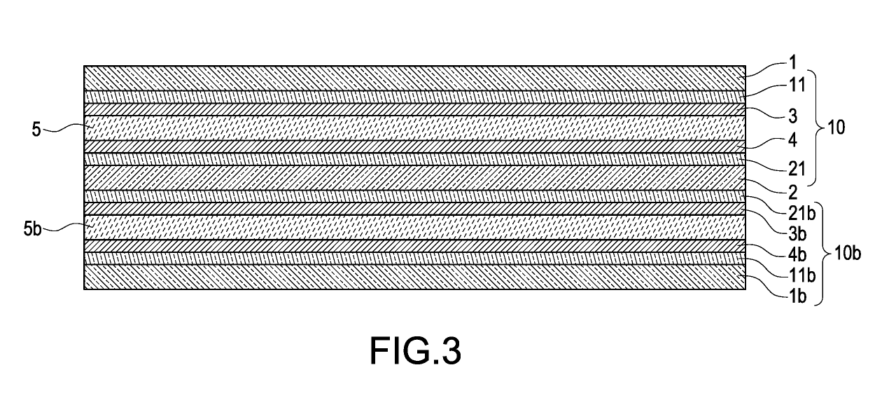

FIG. 3 shows a side view of two composite layers used in a smart window of a third embodiment according to the present invention. Please refer to FIG. 3. The difference between the third embodiment of FIG. 3 and the first embodiment of FIG. 1 is that the composite layer 10 is combined with another composite layer 10b that is provided on a surface of the first soft resin sheet 1 or the second soft resin sheet 2. The composite layer 10b comprises a third curing layer 21b and a fourth curing layer 11b. The third curing layer 21b is provided on a surface of the second soft resin sheet 2, and the fourth curing layer l lb is provided on a surface of the third soft resin sheet 1b. The third curing layer 21b has a third transparent conductive layer 3b on a surface thereof. The fourth curing layer 11b has a fourth transparent conductive layer 4b on a surface thereof. There is a second PDLC layer 5b between the third transparent conductive layer 3b and the fourth transparent conductive layer 4b. In the embodiment of FIG. 3, the third curing layer 21b, the fourth curing layer 11b, the third soft resin sheet 1b, the third transparent conductive layer 3b, the fourth transparent conductive layer 4b and the second PDLC layer 5b have the same structure and materials to FIG. 1, so the explanations can be omitted herein.

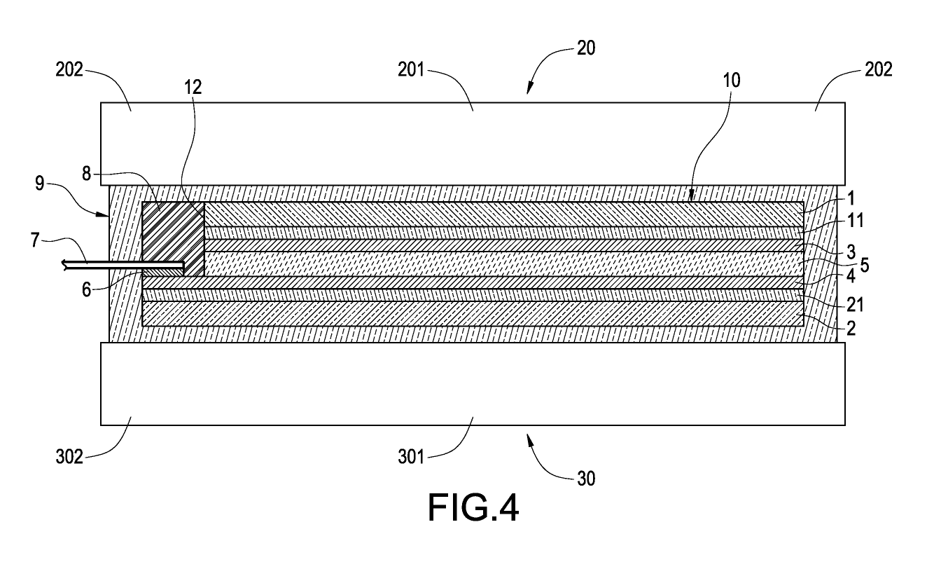

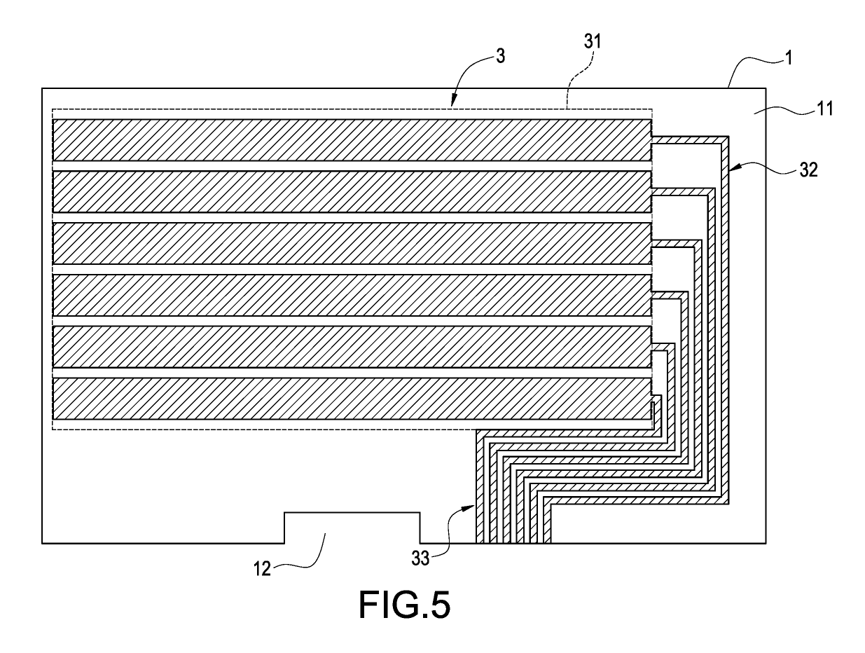

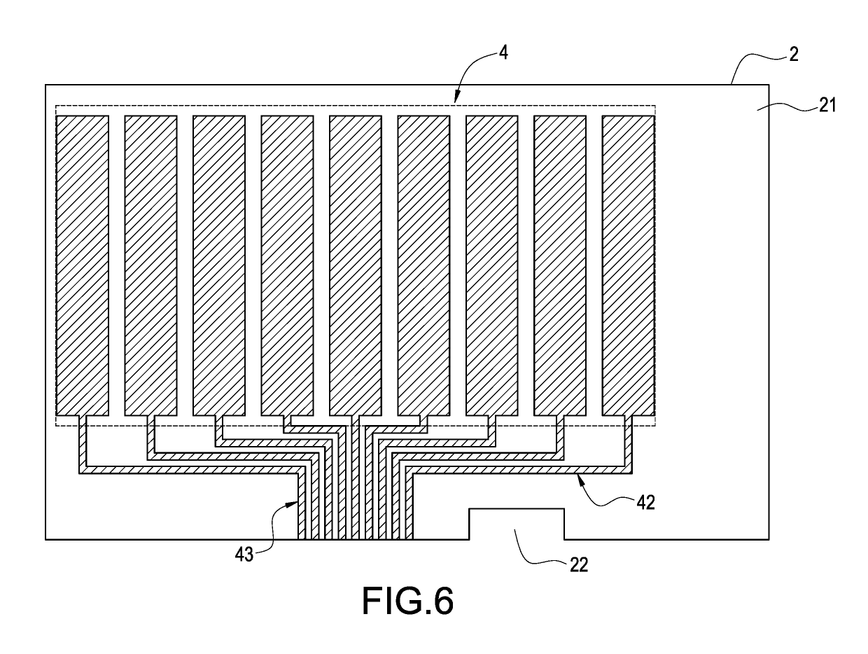

FIG. 4 shows a side view of a composite layer used in a smart window of a fourth embodiment according to the present invention. FIG. 5 shows a top view FIG. 4 from direction of a first soft resin sheet. FIG. 6 shows a top view FIG. 4 from direction of a second soft resin sheet. According to FIG. 5, the first transparent conductive layer 3 comprises a first circuit region 31, a plurality of first leads 32 and a first cable region 33. According to FIG. 6, the second transparent conductive layer 4 comprises a second circuit region 41, a plurality of second leads 42 and a second cable region 43. In addition, the first soft resin sheet 1 has a recess 12 at a side and the second soft resin sheet 2 has a recess 22 at a side. The recess 12 may expose the first cable region 33 of the first transparent conductive layer 3 and the recess 22 may expose the second cable region 43 of the second transparent conductive layer 4.

After the first soft resin sheet 1, the second soft resin sheet 2, the first transparent conductive layer 3, the second transparent conductive layer 4 and a first PDLC layer 5 are assembled, the recess 22 of the second soft resin sheet 2 may expose the first leads 32 of the first cable region 33, the recess 12 of the first soft resin sheet 1 may expose the second leads 42 of the second cable region 43. Also, the exposed first leads 32 and second leads 42 are coated with a conductive adhesive layer 6 respectively. The conductive adhesive layer 6 is silver paste.

After the conductive adhesive layers 6 of the first leads 32 and the second leads 42 are formed, the first leads 32 are electrically connecting to an end of a flexible printed circuit (FPC) 7 and the second leads 42 are electrically connecting to an end of another FPC 7. The FPC 7 has a thickness in a range of 50 um-500 um.

After two FPCs 7, 7 are electrically connecting to the first leads 32 and the second leads 42, the exposed second cable region 43 in the recess 12 of the first soft resin sheet 1 and the FPC 7 is filled in an insulation layer 8, and the exposed first cable region 33 in the recess 22 of the second soft resin sheet 2 and the FPC 7 is filled in another insulation layer 8 so that the recess 12 is coplanar with the first soft resin sheet 1 and the recess 22 is coplanar with the second soft resin sheet 2. The insulation layer 8 is a blue gel or a strippable coating.

After the FPCs 7, 7 and the insulation layers 8, 8 are formed, an optical adhesive layer 9 is provided between an upper light transmission layer 20 and a lower light transmission layer 30. The optical adhesive layer 9 wraps the composite layer 10 inside. Also, the upper light transmission layer 20 can be divided into a visible region 201 and an invisible region 202; and the lower light transmission layer 30 can be divided into a visible region 301 and an invisible region 302. The optical adhesive layer 9 is made of polyvinyl butyral (PVB) resin.

Further, the recesses 12, 22, the FPCs 7, 7, the insulation layers 8, 8 and the optical adhesive layer 9, the upper light transmission layer 20 and the lower light transmission layer 30 of the fourth embodiment may be applied to the second embodiment and the third embodiment, and the additional explanations can be omitted herein.

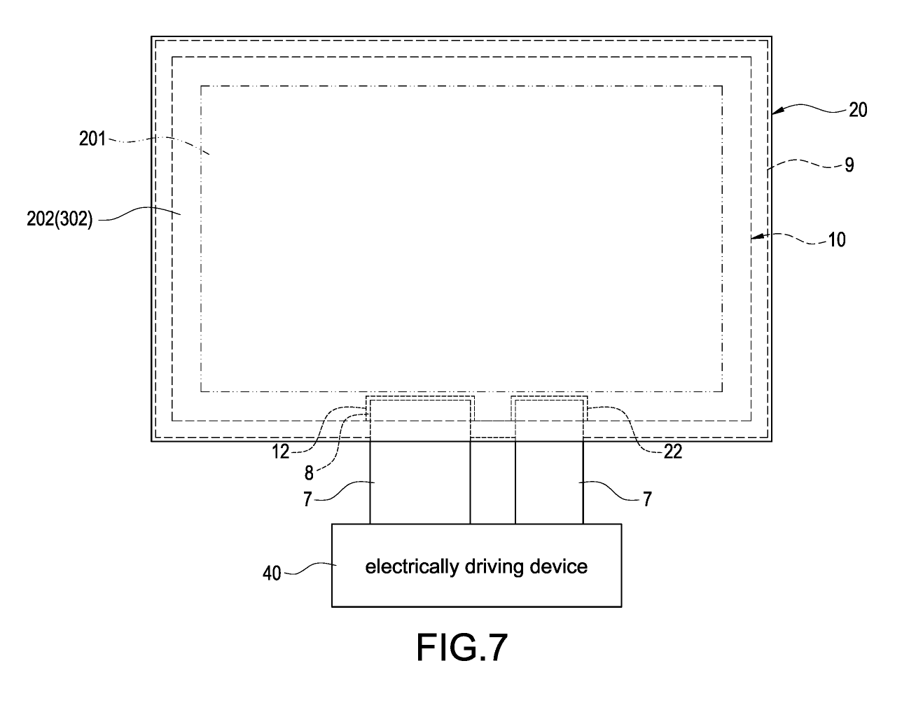

FIG. 7 shows a schematic view of a composite layer of a fourth embodiment electrically connecting to an external electrically driving device according to the present invention. According to FIG. 7, the upper light transmission layer 20 can be divided into a visible region 201 and an invisible region 202; and the lower light transmission layer 30 can be divided into a visible region 301 and an invisible region 302, wherein the invisible regions 202, 302 may be coated by an opaque coating. In FIG. 7, the upper light transmission layer 20 and the lower light transmission layer 30 may be glass or a light transmission material, provided on a surface of a variety of objects and devices comprising, but not limited to cupboards, windows, doors, tables, walls, cars, ships and airplanes, and glass of windows and doors of insulation devices and baking devices. In case that the composite layer 10 is provided on a glass of a car, it has a function of heat insulation. Alternatively, with a combination of the composite layer 10 provided between the upper light transmission layer 20 and the lower light transmission layer 30 as a glass used in windows or doors, it has a function of heat insulation and can create on-demand private spaces. However, the doors herein have a broad meaning, but not limited to the doors of home, and can be the doors of cars, coolers or baking devices. Similarly, the windows can be windows of home, and can be windows of cars.

Further, please refer to FIGS. 5-7, a FPC 7 is electrically connecting to the first cable region 33 of the first transparent conductive layer 3 at an end and another FPC 7 is electrically connecting to the second cable region 43 of the second transparent conductive layer 4 at an end, and the FPCs 7, 7 are electrically connecting to an external electrically driving device 40 at another end respectively. A user may use a touch sensitive operation of a touch sensitive circuit of the composite layer 10 of the smart window to provide a signal instruction or may directly provide a signal instruction to the electrically driving device 40. Accordingly, the corresponding PDLC circuit (not shown) may drive the corresponding regions of the first PDLC layer 5 to conduct the change of light transmission of local region, for example hand writing board, the gray level change of light transmission of PDLC and light transmission control of local region of PDLC, etc.

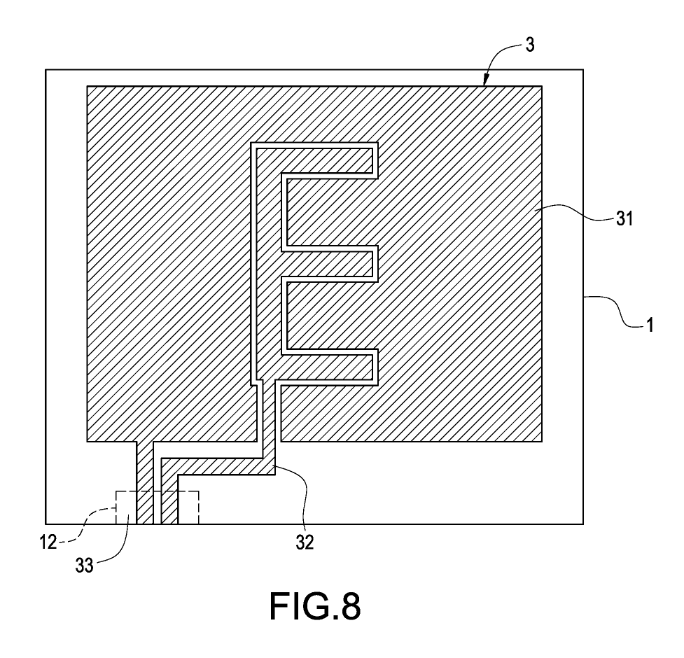

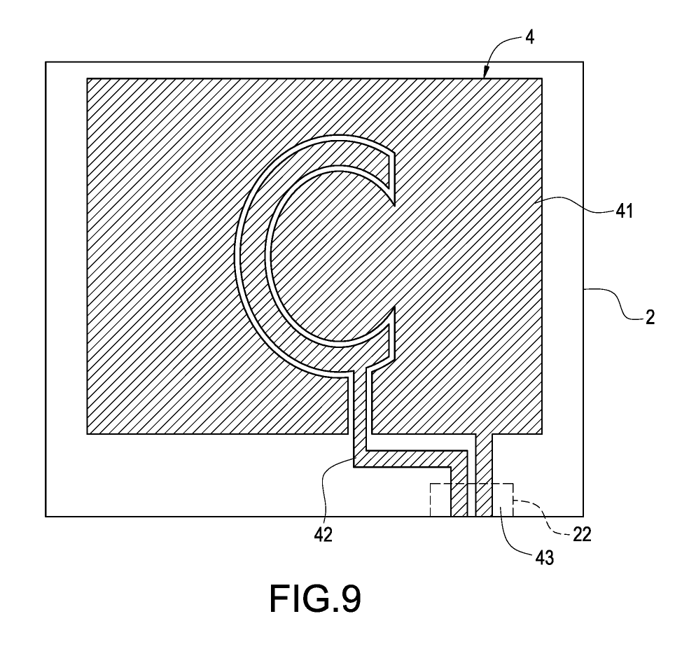

FIG. 8 shows a schematic view of a first image effect of FIG. 1 of a first embodiment according to the present invention. FIG. 9 shows a schematic view of a second image effect of FIG. 1 of a first embodiment according to the present invention. According to FIGS. 7 and 8, the first circuit region 31 of the first transparent conductive layer 3 is etched to form an image of an E letter. After assembling the structure, the change of light transmission of local region to display the image of the E letter is conducted by the control of the electrically driving device 40. According to FIGS. 7 and 9, the second circuit region 41 of the second transparent conductive layer 4 is etched to form an image of a C letter. After assembling the structure, the change of light transmission of local region to display the image of the C letter is conducted by the control of the electrically driving device 40.

According to the present invention, the change of light transmission of local region to display a variety of images is conducted by combining a plurality of transparent conductive layers and PDLC layers. This is different with X-Y dot matrix method and the circuit structure of the electrically driving device and cost can be reduced largely. Also, the images have a good quality.

The invention can achieve the advantages including strengthening of glass, heat insulation of glass and message display. The composite layer of the invention can combine with a variety of objects and devices to produce excellent effect. The invention is not limited to these embodiments, but various variations and modifications may be made without departing from the scope of the invention.

What is claimed is:

1. A smart window comprising at least one composite layer, electrically connected with an external electrically driving device, the composite layer comprising:
a first soft resin sheet, having a first curing layer on a side surface of the first soft resin sheet;
a first transparent conductive layer, provided on a side surface of the first curing layer, and electrically connected with the external electrically driving device, the first transparent conductive layer comprising a first circuit region, a plurality of first leads electrically connecting with the first circuit region and a first cable region electrically connecting with the first leads;
a second soft resin sheet, having a second curing layer on a side surface of the second soft resin sheet;
a second transparent conductive layer, provided on a side surface of the second curing layer, and electrically connected with the external electrically driving device, the second transparent conductive layer comprising a second circuit region, a plurality of second leads electrically connecting with the second circuit region and a second cable region electrically connecting with the second leads;
a first polymer dispersed liquid crystal (PDLC) layer, provided between the first transparent conductive layer and the second transparent conductive layer,
wherein the first circuit region or the second circuit region is driven respectively by the electrically driving device to produce a local change of an electric field for achieving a change of light transmission of local region of the first PDLC layer.

2. The smart window according to claim 1, wherein the first soft resin sheet has a recess at a side for exposing the first cable region of the first transparent conductive layer, and the second soft resin sheet has a recess at a side for exposing the second cable region of the second transparent conductive layer.

3. The smart window according to claim 1, wherein the first leads and second leads are coated with a conductive adhesive layer respectively.

4. The smart window according to claim 3, wherein the conductive adhesive layer is silver paste.

5. The smart window according to claim 1, wherein the conductive adhesive layer of the first leads is electrically connecting to an end of a flexible printed circuit (FPC) and the conductive adhesive layer of the second leads is electrically connecting to an end of another FPC, and the FPCs are electrically connecting to the electrically driving device at another end respectively.

6. The smart window according to claim 1, wherein the first soft resin sheet and the second soft resin sheet are a material of light transmission resin.

7. The smart window according to claim 6, wherein the light transmission resin is polyethylene terephthalate (PET), polyethylene (PE), polyimide (PI), polyamide (PA), polyurethanes (PU) or acrylic resin.

8. The smart window according to claim 1, wherein the first soft resin sheet has a thickness in a range of 10 um-500 um and the second soft resin sheet has a thickness in a range of 10 um-500 um.

9. The smart window according to claim 1, wherein the first curing layer or the second curing layer is a material selected from the group consisting of acrylic resin, epoxy and silica.

10. The smart window according to claim 1, wherein the first curing layer or the second curing layer has a thickness in a range of 1 um-5 um.

11. The smart window according to claim 1, wherein the first transparent conductive layer and the second transparent conductive layer are made of an inorganic conductive material or an organic conductive material.

12. The smart window according to claim 11, wherein the organic conductive material is a conductive material mixing with carbon nanotube or poly-3,4-ethylenedioxythiophene.

13. The smart window according to claim 1, wherein the first transparent conductive layer or the second transparent conductive layer has a thickness in a range of 5 nm-50 um.

14. The smart window according to claim 1, wherein the first PDLC layer is formed of PDLC resins as a main element and mixing with a material selected from the group consisting of UV resins, thermal setting resins and silica.

15. The smart window according to claim 1, wherein the first PDLC layer has a thickness in a range of 1 um-100 um.

16. The smart window according to claim 1, further comprising an upper light transmission layer, a lower light transmission layer and an optical adhesive layer provided between the upper light transmission layer and the lower light transmission layer, and the optical adhesive layer wrapping the composite layer inside.

17. The smart window according to claim 1, wherein the composite layer is attached to another composite layer by the first soft resin sheet or the second soft resin sheet with a transparent adhesive layer.

18. A smart window, electrically connected with an external electrically driving device, comprising:
a first soft resin sheet, having a first curing layer on a side surface of the first soft resin sheet;
a first transparent conductive layer, provided on a side surface of the first curing layer, and electrically connected with the external electrically driving device, the first transparent conductive layer comprising a first circuit region, a plurality of first leads electrically connecting with the first circuit region and a first cable region electrically connecting with the first leads;
a second soft resin sheet, having a second curing layer on a side surface of the second soft resin sheet;
a second transparent conductive layer, provided on a side surface of the second curing layer, and electrically connected with the external electrically driving device, the second transparent conductive layer comprising a second circuit region, a plurality of second leads electrically connecting with the second circuit region and a second cable region electrically connecting with the second leads;
a first polymer dispersed liquid crystal (PDLC) layer, provided between the first transparent conductive layer and the second transparent conductive layer;
a third transparent conductive layer, provided on a side surface of a third curing layer, and electrically connected with the external electrically driving device, the third transparent conductive layer comprising a third circuit region, a plurality of third leads electrically connecting with the third circuit region and a third cable region electrically connecting with the third leads;
a third soft resin sheet, having a fourth curing layer on a side surface of the third soft resin sheet;
a fourth transparent conductive layer, provided on a side surface of the fourth curing layer, and electrically connected with the external electrically driving device, the fourth transparent conductive layer comprising a fourth circuit region, a plurality of fourth leads electrically connecting with the fourth circuit region and a fourth cable region electrically connecting with the fourth leads;
a second polymer dispersed liquid crystal (PDLC) layer, provided between the third transparent conductive layer and the fourth transparent conductive layer,
wherein the first circuit region, the second circuit region, the third circuit region or the fourth circuit region is driven respectively by the electrically driving device to produce a local change of an electric field for achieving a change of light transmission of local region of the first PDLC layer or the second PDLC layer.

19. The smart window according to claim 18, wherein each the first soft resin sheet, the second soft resin sheet and the third soft resin sheet has a recess at a side for exposing the first cable region, the second cable region, the third cable region and the fourth cable region.

20. The smart window according to claim 18, wherein the first leads, the second leads, the third leads and the fourth leads are coated with a conductive adhesive layer respectively.

21. The smart window according to claim 20, wherein the conductive adhesive layer is silver paste.

22. The smart window according to claim 18, wherein the conductive adhesive layers of the first leads, the second leads, the third leads and the fourth leads are electrically connecting to each of an end of a plurality of flexible printed circuits (FPCs), and the FPCs are electrically connecting to the electrically driving device at another end respectively.

23. The smart window according to claim 18, wherein the first soft resin sheet, the second soft resin sheet and the third soft resin sheet are a material of light transmission resin.

24. The smart window according to claim 23, wherein the light transmission resin is polyethylene terephthalate (PET), polyethylene (PE), polyimide (PI), polyamide (PA), polyurethanes (PU) or acrylic resin.

25. The smart window according to claim 18, wherein the first soft resin sheet has a thickness in a range of 10 um-500 um, the second soft resin sheet has a thickness in a range of 10 um-500 um and the third soft resin sheet has a thickness in a range of 10 um-500 um.

26. The smart window according to claim 18, wherein the first curing layer, the second curing layer, the third curing layer or the fourth curing layer is a material selected from the group consisting of acrylic resin, epoxy and silica.

27. The smart window according to claim 18, wherein the first curing layer, the second curing layer, the third curing layer or the fourth curing layer has a thickness in a range of 1 um-5 um.

28. The smart window according to claim 18, wherein the first transparent conductive layer, the second transparent conductive layer, the third transparent conductive layer and the fourth transparent conductive layer are made of an inorganic conductive material or an organic conductive material.

29. The smart window according to claim 28, wherein the organic conductive material is a conductive material mixing with carbon nanotube or poly-3,4-ethylenedioxythiophene.

30. The smart window according to claim 18, wherein the first transparent conductive layer, the second transparent conductive layer, the third transparent conductive layer or the fourth transparent conductive layer has a thickness in a range of 5 nm-50 um.

31. The smart window according to claim 18, wherein the first PDLC layer or the second PDLC layer is formed of PDLC resins as a main element and mixing with a material selected from the group consisting of UV resins, thermal setting resins and silica.

32. The smart window according to claim 18, wherein the first PDLC layer or the second PDLC layer has a thickness in a range of 1 um-100 um.

33. The smart window according to claim 18, further comprising an upper light transmission layer, a lower light transmission layer and an optical adhesive layer provided between the upper light transmission layer and the lower light transmission layer, and the optical adhesive layer wrapping the composite layer inside.
